(19) United States
(12) Patent Application Publication
(10) Pub. No.: US 2020/0269473 A1
(43) Pub. Date: Aug. 27, 2020

(54) ROTATIONAL CASTING MACHINE

(71) Applicants: Lorian Michael Bannis, Gilbert, AZ (US); Tiffany Bopha Ly, Gilbert, AZ (US)

(72) Inventors: Lorian Michael Bannis, Gilbert, AZ (US); Tiffany Bopha Ly, Gilbert, AZ (US)

(21) Appl. No.: 16/784,695

(22) Filed: Feb. 7, 2020

Related U.S. Application Data
(60) Provisional application No. 62/809,598, filed on Feb. 23, 2019.

(51) Int. Cl. B29C 41/06

(52) U.S. Cl. CPC B29C 41/06

(57) ABSTRACT

A method and apparatus for rotationally casting hollow articles includes securing a mold within a clamping member coupled to an inner frame which is further coupled to an outer frame, rotating the outer frame about a first axis, and rotating the inner frame about a second axis that is orthogonal to the first axis. Rotation of the outer frame may be driven by a motor or a manual crank. Furthermore, rotation of the inner frame may be driven by the outer frame. The rotational casting apparatus is adjustable and can accommodate a variety of mold sizes for casting. The rotational casting apparatus may be configured for individual and/or industrial settings.

### CROSS REFERENCE TO RELATED APPLICATIONS

This application claims the benefit of U.S. Provisional Application No. 62/809,598 filed Feb. 23, 2019.

### BACKGROUND

### 1. Field of the Invention

This invention pertains to the art of rotational casting or molding, and more particularly to rotational casting in which multiple frames are rotated about at least two axes. The invention is particularly applicable to rotational casting for the manufacture of hollow objects in conformance with a mold. However, it will be appreciated those skilled in the art that the invention could be readily adapted for use in other environments. Such devices are adjustable to accommodate a variety of mold sizes and shapes.

### 2. Description of Related Art

Many types of apparatus and methods for molding hollow objects are known in the art. For example, a common rotational molding method includes rotating a mold about a plurality of planes as heat-sensitive latex coats the inner surfaces of the mold. These molds are commonly heated to set the latex before the gelled product is removed from the mold. The heating process for curing the latex material can be costly and time consuming, slowing production of parts.

Another common rotational molding machine is one which mounts a plurality of mold carrying arms on a turret which rotates the molds to various operating stations. The various operating stations load the mold with a thermoplastic material, rotate and heat the molds in oven chamber, and cool the molds. The mold is typically rotated about two axes normal to each other during rotation and heating. These machines comprise large industrial equipment, which require large amounts of factory space. In addition, they are expensive to operate and maintain over the life of the machine.

Another common rotational molding machine is one which involves the centrifugal casting about a single axis. In these machines, high unidirectional rotational speeds are utilized to set a polymer mold. The unidirectional rotation of these machines can result in a nonuniform distribution of material within the mold.

The deficiencies found in the currently known methods for molding hollow objects include the limited economic and practical value of the existing machines. A factor limiting the value of the current machines includes the cost and size of the machines. The physical size of many current machines requires a large amount of factory space. Additionally, the complexity of the machine results in excessively high operating costs. Further, the heat applied to many of the rotating molds requires expensive equipment and maintenance costs. For the heated machines, the cooling time needed before the object can be removed increases the production time, tying up the expensive casting equipment.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 1,998,897 of Walter describes a process of manufacture of a rubber article comprising rotating a mold about two axes simultaneously to set a mixture.

U.S. Pat. No. 4,104,357 of Monster Molding Inc. describes a method of rotating a mold about two axes at a low rotational velocity so that the centrifugal force on the molding mixture is negligible.

U.S. Pat. No. 4,292,015 of Hritz describes a method and apparatus for the rotational molding of thin-walled articles. The apparatus comprises rotating the mold about a first axis while rocking the mold through a selective arc about a second axis and heating the mold to cure the plastic material.

U.S. Pat. No. 4,583,932 of Kingsland Ltd. describes a rotational molding machine comprising a heat-insulated enclosure mounted to rotate on a frame about a substantially horizontal axis, which enclosure comprises means for receiving and driving in rotation at least one mold about an axis perpendicular to the axis of rotation of the enclosure.

U.S. Pat. No. 4,738,815 of FSP International Inc. describes a rotational molding machine having an oven enclosed by a pivotable top clam shell cover.

U.S. Pat. No. 5,039,297 of Confluence Holdings Corp. describes a rotational molding apparatus comprising an oven chamber, a frame which pivotally supports the oven, and an oven pivot axis that causes a pendular motion to swing the mold in an arc as the oven pivots.

U.S. Pat. No. 5,316,701 of Innovative Process Corp. describes a method of rotational molding about at least three axes.

U.S. Pat. No. 5,441,396 of Nicem Srl describes a machine for the centrifugal molding of low-melting metals or synthetic materials which comprises supports that rotate about a substantially vertical rotation axis and plates that are used to enclose the mold and move in a direction parallel to the vertical rotation axis.

European Patent 1,961,398 of Allergan Inc. describes a method of multi-axis rotation for producing medical castings. The method comprises two piece with sprue openings for the insertion of liner material, and are rotated about at least two axes.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention provides among other things an apparatus and method for multi directional rotational molding or casting of materials within a multi frame assembly. The rotational molding apparatus and method of the invention provides a simple and convenient means for the small-scale production of uniform hollow products efficiently and inexpensively.

The method of the invention includes the steps of securing a mold within a clamping member coupled to an inner frame which is further coupled to an outer frame, rotating the outer frame about a first axis, and rotating the inner frame about a second axis that is orthogonal to the first axis. The rotation of the frames can be driven by a variable speed motor or a manual crank.

One benefit obtained by the present invention is to provide a small rotational casting machine that is extremely simple in design and use. The present invention can fit on a standard desktop or table to allow individuals to utilize the machine at home without the use of a factory or large production space. Additionally, no special training or mechanical knowledge is required to utilize the rotational casting machine. The present invention allows for artists and inventors to produce replicas of their own work at home or in an office space for a relatively low operating cost.

An additional significant benefit of the present invention is to utilize multidirectional rotation of the frames and fast setting materials so that high temperatures during rotation are not needed. This reduces the overall equipment investment, and substantially lowers the operating costs associated with the casting machine.

Yet another benefit of the present invention is the two plates used to secure the object in the clamping member. These two plates allow for objects of varying sizes and shapes to be secured in the rotational casting machine. Further, the size of the frames can be scaled to allow the size range of the objects produced to be additionally expanded. Accordingly, the present invention allows for the utilization of the same machine for a range of mold sizes, also lowering the operating costs associated with casting objects of varying dimensions.

In one embodiment, a diamond shaped base for the support structure stabilizes the rotational casting machine on a flat surface. A motor drives the rotation of an outer frame along a first axis, and a pulley driven by the rotation of the outer frame drives the rotation of an inner frame along a second axis. The second axis is orthogonal to the first axis for purposes of uniformly coating the interior cavity of the mold. The mold is secured between two plates of a clamping member that rotates with the inner frame.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a schematic front view of the rotational casting machine of the present invention.

FIG. 2 depicts a top view of the machine shown in FIG. 1.

FIG. 3 depicts a side view of the machine shown in FIG. 1.

FIG. 4 depicts a front view of the machine shown in FIG. 1 after setting in rotation.

FIG. 5 depicts a front view, showing the outer frame pulley driven by the motor.

FIG. 6 depicts a front view of the rotational casting machine wherein the motor of FIG. 1 is replaced by a manual crank.

FIG. 7 depicts a front view of a pulley.

FIG. 8 depicts a top view of the pulley.

FIG. 9 depicts an isometric view of the pulley.

FIG. 10 depicts a front view of a shaft, where the gears are of equal sizes.

FIG. 11 depicts a front view of the shaft, where the gears are of different sizes.

FIG. 12 depicts a front view of the pulley coupled to the shaft of the outer frame.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

For the foregoing reasons, there is a need, therefore, for a multi directional rotational casting machine that can accommodate a variety of mold sizes, that is inexpensive to procure and utilize, that is simple to use, and that is small enough for use without requiring large factory or manufacturing space.

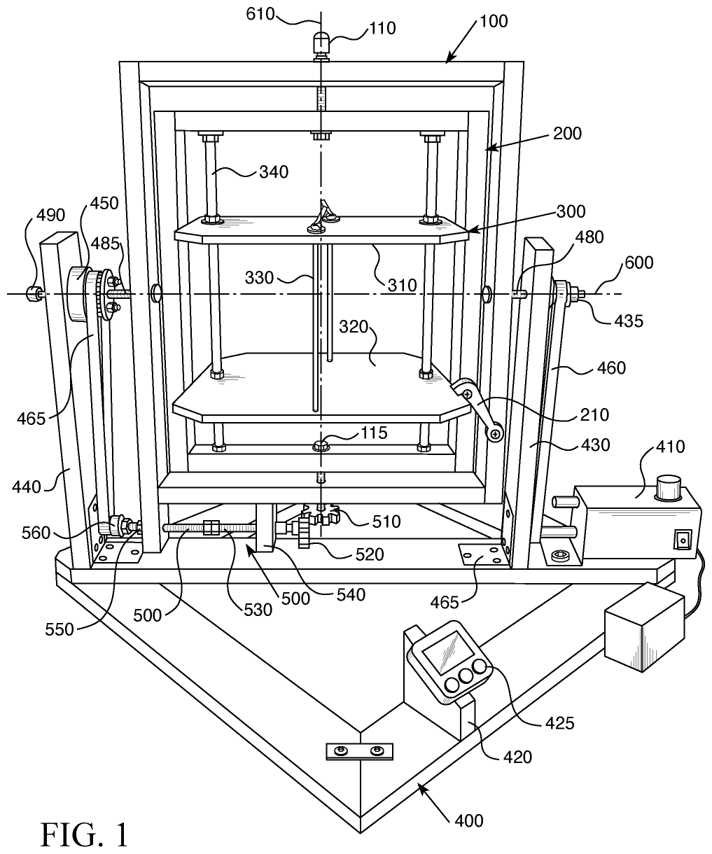

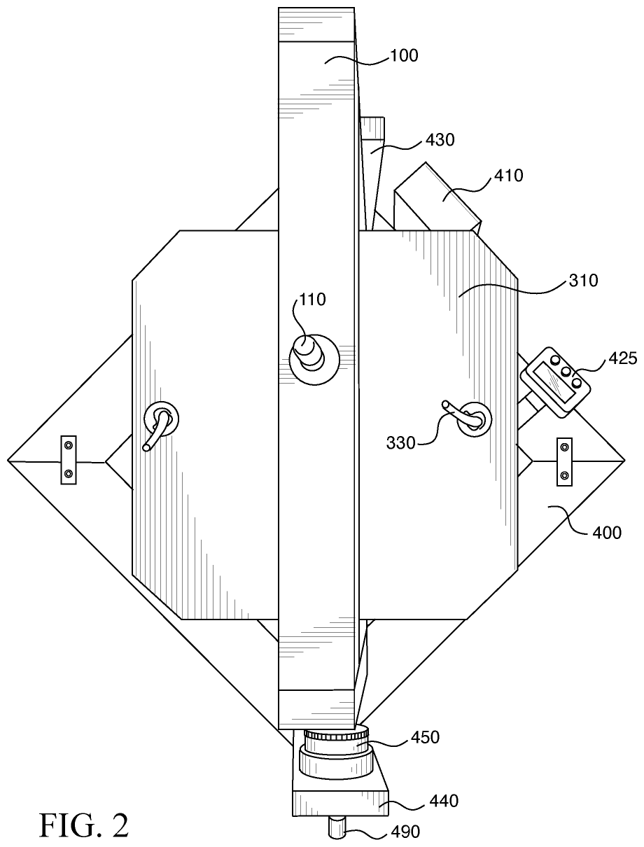

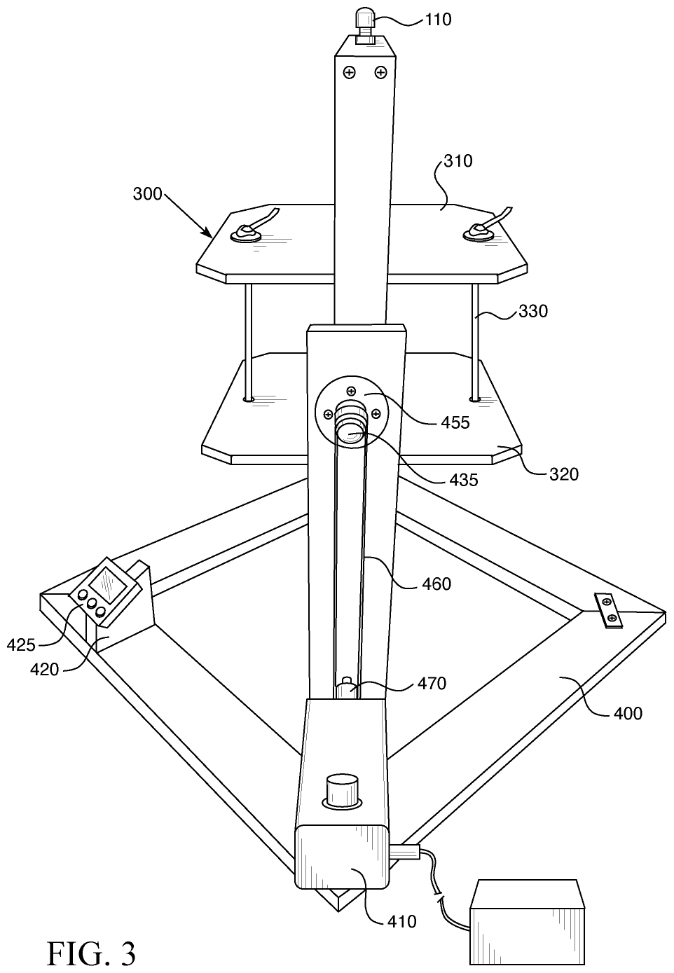

FIG. 1 illustrates a front view of a rotational casting machine according to one exemplary embodiment of the invention. With combined references to FIG. 1, FIG. 2, and FIG. 3, the rotational casting machine generally includes a support structure rotatably coupled to an outer frame 100, the outer frame 100 rotatably coupled to an inner frame 200, and a clamping member 300 configured to receive a container.

The support structure comprises a base member 400, a first supporting arm 430, and a second supporting arm 440. The first supporting arm 430 and second supporting arm 440 may extend substantially perpendicularly from the base member 400 on opposite sides of the base member 400. Additionally, brackets may be used to provide additional support between the base member 400 and first supporting arm 430 or the second supporting arm 440. In various embodiments, the support structure further comprises a timer stand 420 and a timer 425. The timer 425 may be utilized to set a desired length of time for operating the rotational casting machine and alert the user when that length of time has passed.

In one embodiment, the base member 400 comprises a diamond shape. In other embodiments, the base member 400 may comprise an I-frame shape, a square shape, a triangular shape, or any substantially symmetrical shape. A substantially symmetrical or regular polygonal base member shape is preferred for providing stability and even weight distribution across the base member 400.

In one embodiment, the outer frame 100 and inner frame 200 comprise substantially rectangular shapes. In other embodiments, the frames 100, 200 may comprise square shapes. In other embodiments, the frames 100, 200 may comprise diamond shapes. The frames 100, 200 may comprise any symmetrical shape such that the inner frame 200 may fit within the outer frame 100. The inner frame 200 comprises a height and width that are less than the height and width of the outer frame 100, respectively.

In various embodiments, the outer frame 100 is rotatably coupled to the support structure via a first outer frame fastener 480 and a second outer frame fastener 485. In accordance with various embodiments, the first outer frame fastener 480 may comprise a bolt, a rod, a pin, or any other suitable fastener whereby the outer frame is rotatably mounted to the support structure. The second outer frame fastener 485 may be similar to the first outer frame fastener 480.

In various embodiments, the outer frame 100 is rotatably coupled to the inner frame 200 via a first inner frame fastener 115 and a second inner frame fastener 110. In accordance with various embodiments, the first inner frame fastener 115 may comprise a bolt, a rod, a pin, or any other suitable fastener whereby the inner frame is rotatably mounted to the outer frame. The second inner frame fastener 110 may be similar to the first inner frame fastener 115.

The rotational casting machine may comprise a first outer frame fastener 480 for rotatably coupling the outer frame 100 to the base member 400. A first pulley 435 may be coupled to the first outer frame fastener 480 and a first belt 460. The first outer frame fastener 480 may rotate with the first pulley 435. Furthermore, the outer frame 100 rotates with the first outer frame fastener 480. In this regard, the first pulley 435 may drive rotation of the outer frame 100, about a first axis 600, via the first outer frame fastener 480.

A shaft 500 may be rotatably coupled to the outer frame 100 at a location distal to the first axis 600. The shaft 500 comprises a shaft frame 540 extending substantially perpendicularly to the outer frame 100. The shaft further comprises a fastener 530 which couples to the outer frame 100 and shaft frame 540. The shaft further comprises a shaft end 560 which is coupled to a second belt 465.

As the outer frame 100 rotates about the first axis 600, rotation of the shaft 500 is driven by a second belt 465 coupled between the shaft 500 and a second pulley 450. The second pulley 450 may be coupled to the second supporting arm 440 of the support structure. In various embodiments, the second pulley 450 is coaxial with the first axis 600. Furthermore, the second pulley 450 may not rotate during operation. Stated differently, the second pulley 450 may be stationary. In this regard, rotation of the outer frame 100 drives rotation of the shaft 500, via the second belt 465.

The rotational casting machine may further comprise a first inner frame fastener 115 and a second inner frame fastener 110 for rotatably coupling the inner frame 200 to the outer frame 100. The inner frame 200 may rotate with respect to the outer frame 100 about a second axis 610. The second axis 610 may be orthogonal to the first axis 600. The inner frame 200 may be mounted to the first inner frame fastener 115. An exposed end of the first inner frame fastener 115 may be covered with a fastener cap 490. The first inner frame fastener 115 may be operatively coupled to the shaft 500, whereby rotation of the shaft 500 drives rotation of the first inner frame fastener 115, which consequently causes rotation of the inner frame 200 about the second axis 610.

In various embodiments, the shaft 500 is coupled to the first inner frame fastener 115 via a first gear 510 and a second gear 520. The first gear 510 may be mounted to the shaft 500. The second gear 520 may be mounted to the first inner frame fastener 115.

The clamping member 300 is coupled to, and rotates with, the inner frame 200. The clamping member 300 may comprise a first plate 310 and a second plate 320. The first plate 310 and second plate 320 can vary in size and shape to accommodate a variety of container sizes and shapes. The clamping member 300 further comprises a plurality of support rods 340 which are placed opposite of each other. Stated differently, each plate 310, 320 may comprise a first side and a second side located opposite the plate 310, 320 from the first side. Each plate 310, 320 may comprise a first support rod disposed closer to the first side than the second side and a second support rod disposed closer to the second side than the first side. The plurality of support rods 340 allow the distance between the plates 310, 320 to be adjusted to accommodate containers of different sizes. Each plate 310, 320 may further comprise a third side and a fourth side located opposite the plate 310, 320 from the third side. The clamping member 300 may further comprise cords 330 on opposing sides of the plates 310, 320 in order to provide enhanced stabilization for the container placed between the plates 310, 320. In this regard, each plate 310, 320 may comprise a cord 330 disposed closer to the third side than the fourth side and a cord 330 disposed closer to the fourth side than the third side. A frame lock 210 may be engaged to keep the plates 310, 320 from moving while a container is being secured.

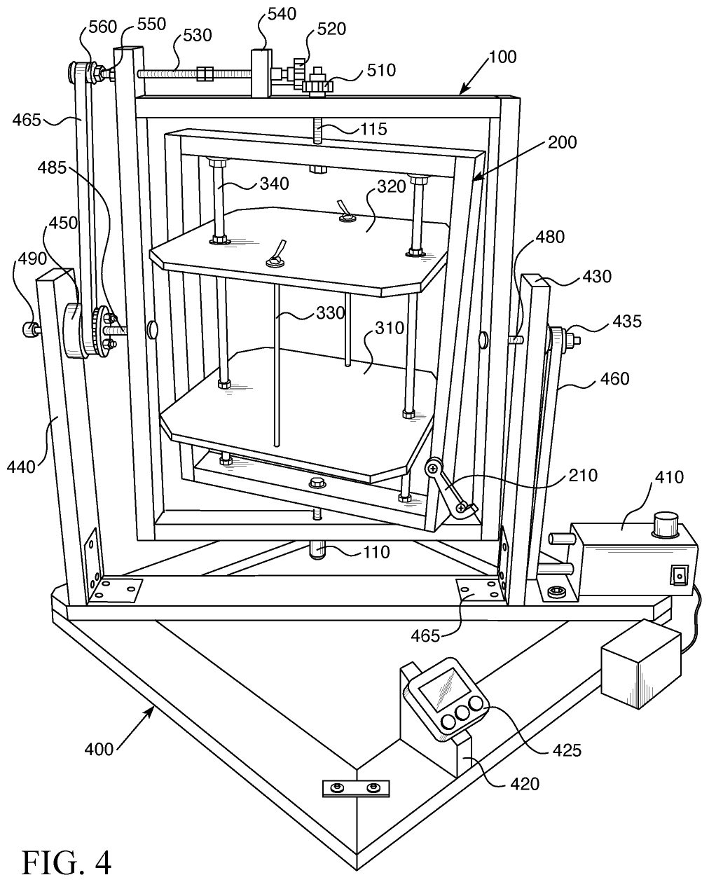

FIG. 4 depicts the rotational casting machine after setting the rotational casting machine in rotation. To use the rotational casting machine, a container is secured within the clamping member 300. The clamping member 300 is coupled to and rotates with the inner frame 200. The first pulley 435 is then rotated, which in turn rotates the outer frame 100 about a first axis 600 with respect to the support structure. As the shaft 500 is coupled to the outer frame 100, the shaft 500 rotates with respect to the outer frame 100 in response to the rotation of the outer frame 100. The inner frame 200 rotates about a second axis 610 in response to the rotation of the shaft 500, thereby imparting multi axis rotation on the container.

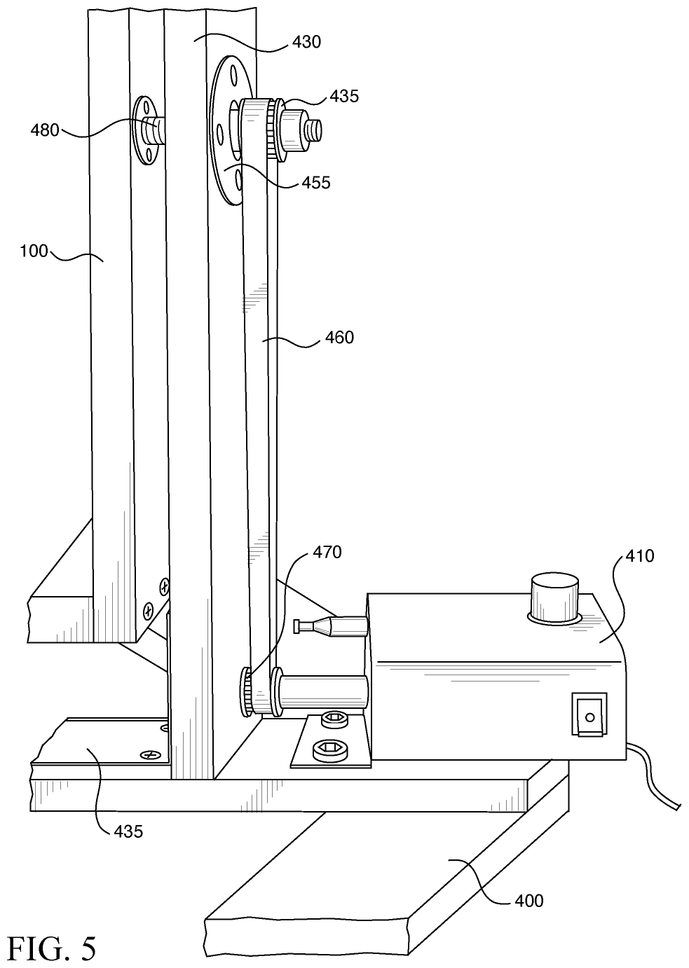

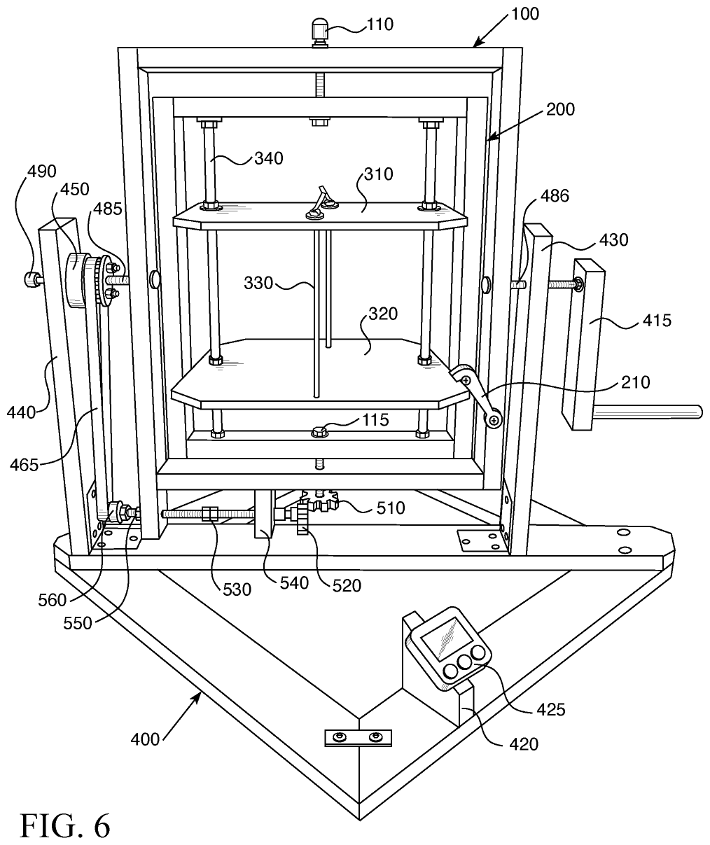

FIG. 5 depicts a front view, showing the first pulley 435 driven by the motor 410. In one embodiment, the rotation of the rotational casting machine is driven by a variable speed motor 410. In other embodiments, the variable speed motor 410 may be replaced by a manual crank 415, as depicted in FIG. 6.

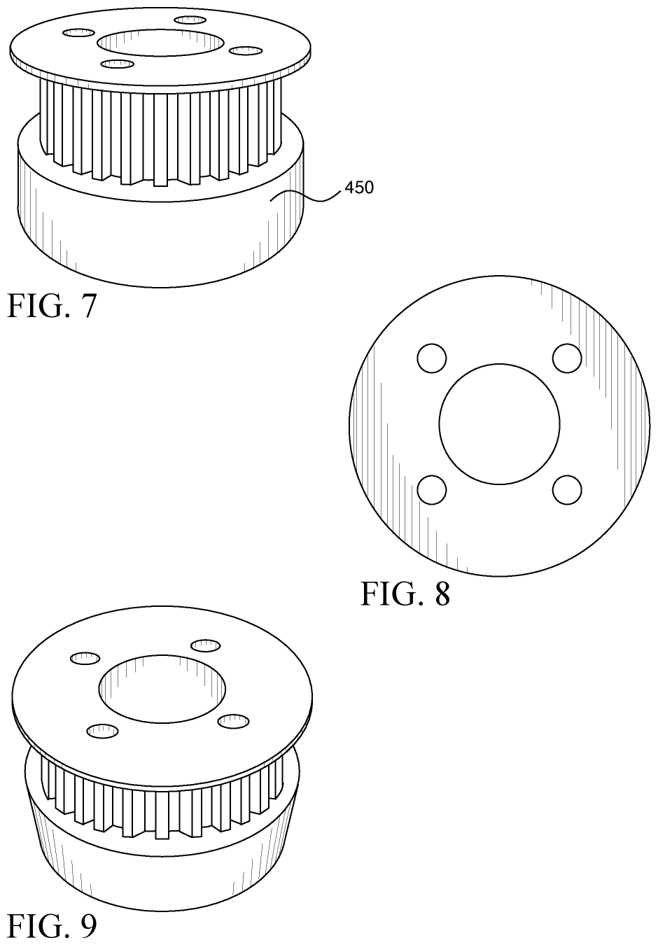

FIG. 7, FIG. 8, and FIG. 9 illustrate an exemplary pulley. The first pulley 435 and or the second pulley 470 may be similar to pulley 450.

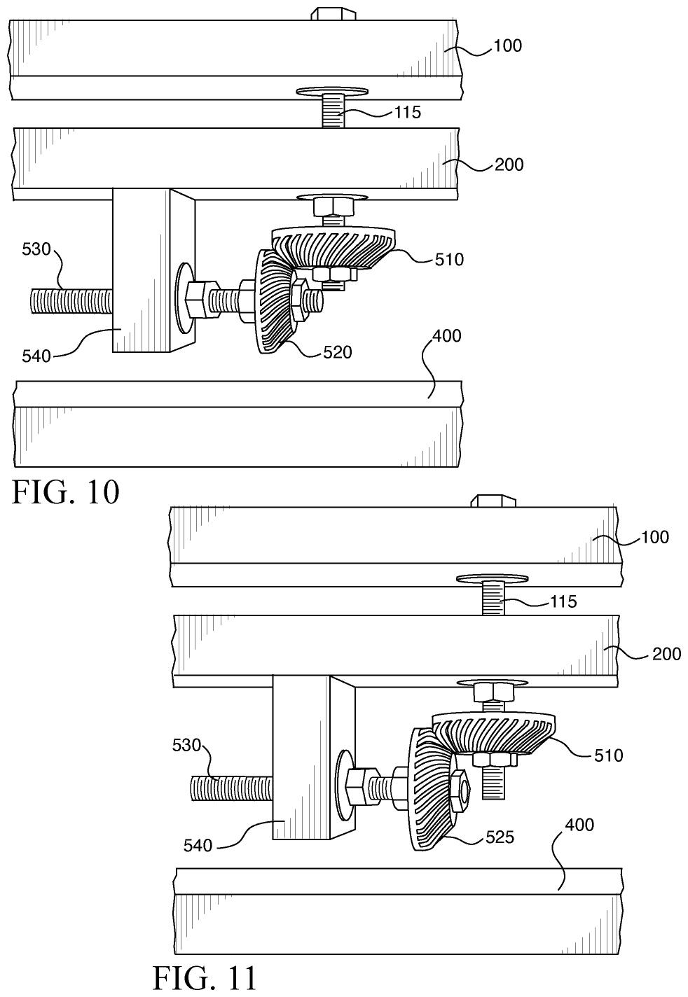

FIG. 10 depicts a front view of a shaft 500, where the gears 510, 520 are of equal sizes. In this regard, the first gear 510 and the second gear 530 may comprise equal diameters. In this regard, the rotation of the shaft 500 and the first inner frame fastener 115 rotate at a 4:1 ratio.

FIG. 11 depicts a front view of the shaft 500, where the gears 510, 525 are of different sizes. In this regard, the first gear 510 may comprise a diameter which is greater than a diameter of the second gear 525. In this regard, the rotation of the shaft 500 and the first inner frame fastener 115 rotate at a 1:x ratio, where x is greater than 1. In this manner, the inner frame 200 may rotate faster than the outer frame 100. However, in accordance with various embodiments, the gears 510, 525 may be configured to cause the inner frame 200 to rotate slower than a rotational velocity of the outer frame 100.

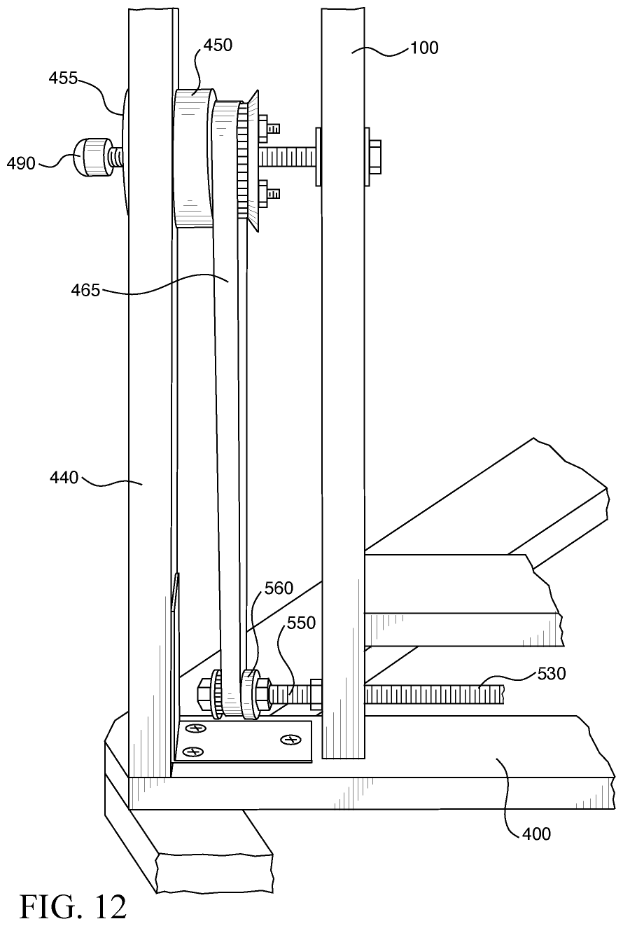

FIG. 12 depicts a front view of the second pulley 470 coupled to the shaft 500 of the outer frame 100. A bearing cover 455 may be used to contain bearings that support the second outer frame fastener 485. A fastener cap 490 may be used to provide a protective surface over an exposed end of the second outer frame fastener 485.

The clamping member 300 is configured to hold and secure containers of various shapes and sizes. In one embodiment, the container comprises a mold for casting a hollow object. The machine may be used for other tasks that require rotation of a container as well, such as mixing a paint can.

In one embodiment, the support structure, outer frame 100, and inner frame 200 are comprised of wood. In other embodiments, the rotational casting machine may be comprised of other materials. For example, in accordance with various embodiments, the machine may be comprised of plastic, metal, or combinations thereof

We claim:

1. A rotational casting machine comprising:
a support structure comprising a base member; a first supporting arm; and a second supporting arm, the first supporting arm and the second supporting arm extending substantially perpendicularly from the base member and located on opposite sides of the base member;
an outer frame rotatably coupled to the support structure;
an inner frame rotatably coupled within the outer frame;
a clamping member disposed within the inner frame;
a first pulley coupled to the outer frame and the first supporting arm;
a shaft rotatably mounted to the outer frame;
a second pulley coupled to the shaft and the second supporting arm;
wherein:
the outer frame is configured to rotate about a first axis with respect to the support structure in response to rotation of the first pulley;
the shaft is configured to rotate with respect to the outer frame in response to the outer frame rotating about the first axis;
the inner frame is configured to rotate with respect to the outer frame about a second axis that is orthogonal to the first axis in response to rotation of the shaft; and
the clamping member is configured to receive a container.

2. The rotational casting machine of claim 1, wherein the shaft comprises a first gear and a second gear of substantially equal sizes.

3. The rotational casting machine of claim 1, wherein the shaft comprises a first gear and a second gear of differing sizes.

4. The rotational casting machine of claim 1, wherein the base member comprises a diamond shape.

5. The rotational casting machine of claim 1, wherein a height of the inner frame is less than a height of the outer frame, and a width of the inner frame is less than a width of the outer frame.

6. The rotational casting machine of claim 1, wherein a first center point of the first pulley and a second center point of a second pulley are aligned on a common axis.

7. The rotational casting machine of claim 1, wherein the clamping member comprises a first plate and a second plate, and a distance between the first plate and the second plate is adjustable.

8. The rotational casting machine of claim 1, wherein the shaft is coupled to the second pulley via a belt.

9. The rotational casting machine of claim 1, wherein the second pulley is fixed with respect to the support structure.

10. The rotational casting machine of claim 1, wherein a motor drives rotation of the first pulley with respect to the support structure.

11. The rotational casting machine of claim 1, wherein a manual crank drives rotation of the first pulley with respect to the support structure.

12. A method of rotationally casting, comprising:
inserting a container into a clamping member of a rotational casting machine, the rotational casting machine comprising:
a support structure comprising a base member; a first supporting arm; and
a second supporting arm, the first supporting arm and the second supporting arm extending substantially perpendicularly from the base member and located on opposite sides of the base member; the support structure rotatably coupled to an outer frame;
an inner frame rotatably coupled within the outer frame;
a clamping member within the inner frame;
a first pulley coupled to the outer frame and the first supporting arm;
a shaft mounted to the outer frame; and
a second pulley coupled to the shaft and the second supporting arm;
rotating the first pulley;
rotating the outer frame about a first axis with respect to the support structure in response to the rotation of the first pulley;
rotating the shaft with respect to the outer frame, in response to the outer frame rotating about the first axis; and
rotating the inner frame about a second axis that is orthogonal to the first axis, in response to the rotation of the shaft.

13. The method of rotationally casting of claim 12, wherein the shaft comprises a first gear and a second gear of substantially equal sizes.

14. The method of rotationally casting of claim 12, wherein the shaft comprises a first gear and a second gear of differing sizes.

15. The method of rotationally casting of claim 12, wherein a first center point of the first pulley and a second center point of a second pulley are aligned on a common axis.

16. The method of rotationally casting of claim 12, wherein the clamping member comprises a first plate and a second plate, and a distance between the first plate and the second plate is adjustable.

17. The method of rotationally casting of claim 12, wherein the shaft is coupled to the second pulley via a belt.

18. The method of rotationally casting of claim 12, wherein the second pulley is fixed with respect to the support structure.

19. The method of rotationally casting of claim 12, wherein a motor drives rotation of the first pulley with respect to the support structure.

20. The method of rotationally casting of claim 12, wherein a manual crank drives rotation of the first pulley with respect to the support structure.
